(19) United States
(12) Patent Application Publication
(10) Pub. No.: US 2015/0144436 A1
(43) Pub. Date: May 28, 2015

(54) Parking-Assist Curb with Plug

(71) Applicant: Solutions Defined, LLC, Bloomfield Hills, MI (US)

(72) Inventor: Jon Craig Bonk, Bloomfield Hills, MI (US)

(21) Appl. No.: 14/549,650

(22) Filed: Nov. 21, 2014

Related U.S. Application Data
(60) Provisional application No. 61/907,433, filed on Nov. 22, 2013.

(51) Int. Cl. B60T 3/00

(52) U.S. Cl. CPC B60T 3/00
USPC 188/32

(57) ABSTRACT

A parking-assist curb that helps a driver park a vehicle at a desired spot, such as in a residential garage. The vehicle's wheel(s) abut the parking-assist curb, and the abutment serves as a signal to the driver to put the vehicle in park. The parking-assist curb has a body with an opening, and has a plug inserted into the opening. A ballast mater can fill an interior of the body.

### CROSS-REFERENCE TO RELATED APPLICATIONS

This application claims the benefit of U.S. provisional patent application No. 61/907,433 filed Nov. 22, 2013, the entire contents of which are hereby incorporated by reference.

### TECHNICAL FIELD

The present disclosure relates generally to ways of assisting a driver park a vehicle at a desired spot, and more particularly relates to curbs used to assist drivers when parking their vehicles.

### BACKGROUND

Drivers can sometime experience a bit of difficulty parking their vehicles (e.g., cars, trucks, vans, SUVs) in driveways, garages, and in other places. For instance, it is not uncommon for a driver to pull in their garage too far and unintentionally bump the garage's back wall, or pull into their garage not far enough and risk the garage's door shutting on their vehicle. The techniques employed to address this problem range from the simplistic like a tennis ball hanging from a string, to the overly complex like sensors equipped in the vehicle or permanently fixed concrete curbs.

### SUMMARY

In one embodiment, a parking assist-curb includes a body and a plug. The body has one or more wall(s). The wall(s) have an abutment region that engages a vehicle tire in use, and have a bottom region that confronts the ground upon which the parking-assist curb is situated when in use. The body also has an opening and defines an interior for locating a ballast material therein. The plug has a groove. In order to close the opening in the body and contain ballast material, the plug is inserted into the opening and the groove captures a portion of the body. The portion that is captured partly or more surrounds the opening.

In another embodiment, a parking-assist curb includes a body and a plug. The body has one or more wall(s). A single opening is defined in the wall(s), and an interior is defined by the wall(s). The plug is inserted into the opening in order to close the opening. The plug has a groove, a first flange, and a second flange. The groove is defined in part by a first flange surface of the first flange, by a second flange surface of the second flange, and by an inside surface that spans between the first and second flange surfaces. The first and second flanges have an outboard extent that is greater than an extent of the groove. When the plug is inserted into the opening, a portion of the wall that partly or more surrounds the opening is received in the groove, and the first and second flanges overlie the portion of the wall in order to maintain insertion of the plug into the opening.

### BRIEF DESCRIPTION OF THE DRAWINGS

The following detailed description of embodiments refers to the accompanying drawings, in which:

FIG. 1 is a perspective view of a parking-assist curb;

FIG. 2 is a side view of the parking-assist curb;

FIG. 3 is a sectional view of the parking-assist curb taken at 3-3 in FIG. 1;

FIG. 4 is a bottom view of the parking-assist curb;

FIG. 5 is a perspective view of a plug of the parking-assist curb; and

FIG. 6 is an enlarged sectional view of the plug inserted in an opening of the parking-assist curb.

### DETAILED DESCRIPTION

The figures depict a parking-assist curb 10 that is used to help a driver park their vehicle (e.g., car, truck, van, SUV) at a desired spot. The parking-assist curb 10 can be situated and set on the ground G. When a vehicle is moving toward the parking-assist curb 10 and its wheel VW comes into contact and abuts the parking-assist curb, the driver knows that the desired spot has been reached and can then put their vehicle into parking mode and turn the vehicle's engine off, if desired. The parking-assist curb 10 may come in handy in residential garages where it is not uncommon for a driver to pull their vehicle in the garage at a distance that is too short or too far, both of which are usually unwanted. The parking-assist curb 10 can also be used in other applications.

The parking-assist curb 10 can have different designs and constructions depending upon, among other considerations, the application in which it will be used. In the example set forth in the figures, the parking-assist curb 10 includes a body 12, a ballast material 14, and a plug 16. Other examples of parking-assist curbs can include more or less components than this; for example, the parking-assist curb could be supplied as a commercial product with only the body and plug, and with the ballast material to be added post-purchase by the consumer or end-user.

The body 12 constitutes the primary structure of the parking-assist curb 10. It can be composed of a plastic material such as a high-density polyethylene (HDPE) material, or another material including non-plastic materials. And depending on the material from which it is made, the body 12 can be manufactured via a blow molding process or another process. Plastic materials and blow molding processes, in particular, can produce a relatively inexpensive, lightweight, and recyclable parking-assist curb 10. Still, other materials and processes are possible.

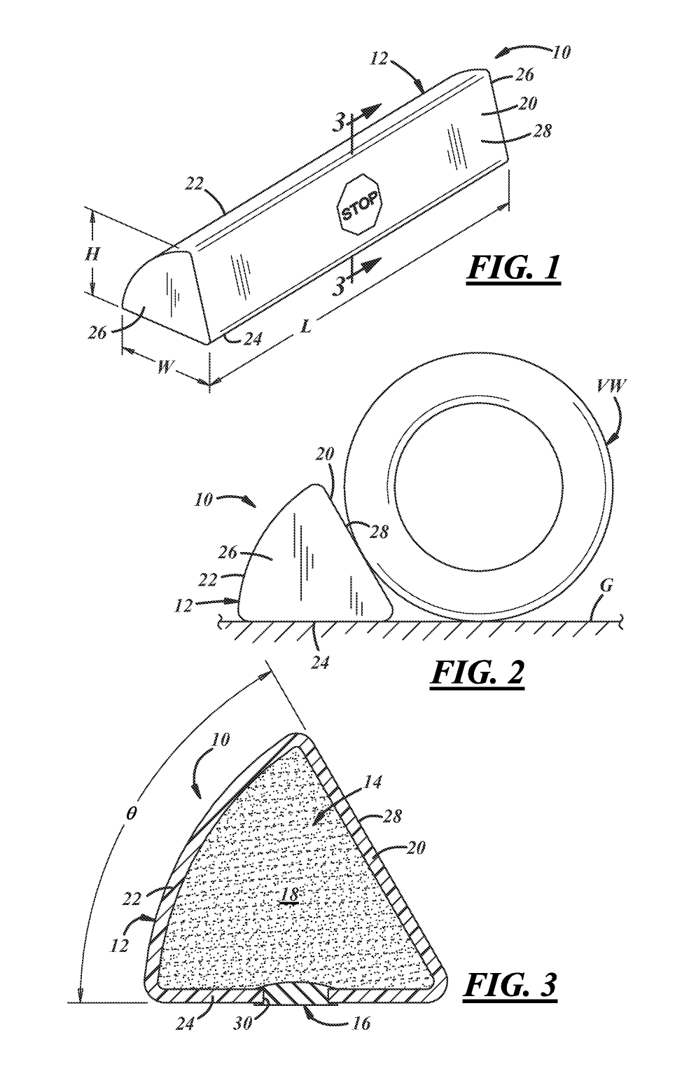

Referring to FIGS. 1-4, the body 12 can have a three-dimensional and somewhat polygonal shape. The shape in the figures has an elongated length L that in one specific example can be approximately 2.4 inches (609.6 millimeters); other examples can include other lengths including a length value approximating the distance between two front wheels or two rear wheels of a typical vehicle (this distance is also called the axle track) so that both of a vehicle's wheels come into contact and abut the parking-assist curb 10. Furthermore, the shape has a height H that in one specific example can be approximately 5 inches (127 millimeters); other height values are possible and may depend on the size of the vehicle wheel VW (i.e., the larger the vehicle wheel, the greater the height). Still further, the shape has a width W that in one specific example can be approximately 5 inches (127 millimeters); and as before, other width values are possible and may depend on the size of the vehicle wheel VW.

Still referring to FIGS. 1-4, the body 12 is made up of several walls that together define an interior 18. The interior 18 is almost fully enclosed by the body's walls and provides an empty space that is filled partly or more by the ballast material 14. In other examples not shown in the figures, the body could be made of a single wall without distinguishable and discrete walls; in this case, the single wall would have different regions such as an abutment region and a bottom region, both of which correspond respectively to the abutment wall and bottom wall described below. In the example of the figures, the body 12 has an abutment wall 20, a back wall 22, a bottom wall 24, and a pair of side walls 26.

The abutment wall 20 is the part of the parking-assist curb 10 that is meant to be engaged by the vehicle wheel VW. In particular, the abutment wall 20 has an abutment surface 28 that comes into direct contact with an exterior tread of the vehicle wheel VW, as illustrated in FIG. 2. The abutment surface 28 can have an indicium on it to augment the visibility of the parking-assist curb 10 to a driver—a stop sign is shown in FIG. 1. The indicium can be brightly colored for enhanced discernability. In other examples, no indicium need be used. As perhaps shown best in FIG. 3, the abutment wall 20 has a generally planar conformation and is set at an angle θ with respect to the ground G. It has been found that an angle θ ranging between approximately 50 degrees (° ) and approximately 70°, and preferably at approximately 60°, will suitably and effectively indicate to the driver that the desired spot has been reached upon abutment with the wheel VW. Other values for the angle θ are possible in other examples, but if the angle θ is too low the wheel VW may simply ride over the parking-assist curb 10 without proper indication, and if the angle θ is too great the wheel may simply push the parking-assist curb forward over the ground G.

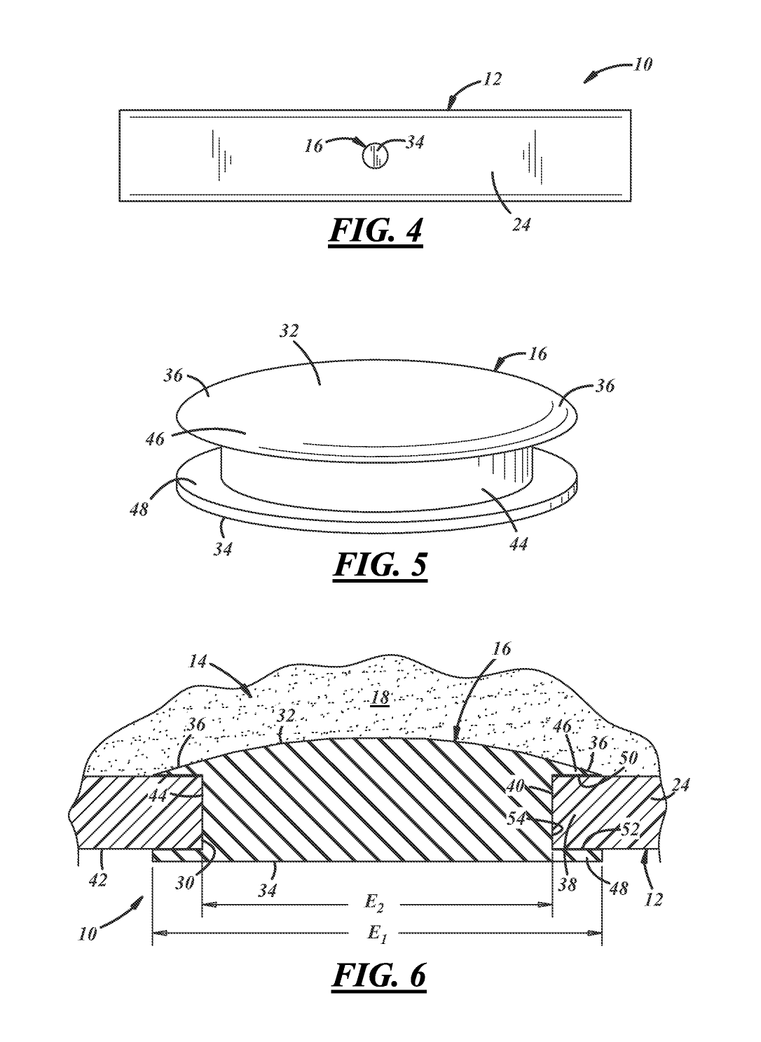

Opposite the abutment wall 20, the back wall 22 has a generally arcuate extent in sectional profile as perhaps shown best in FIG. 3. The bottom wall 24 spans between the abutment and back walls and has a generally planar conformation like the abutment wall 20, as depicted in FIGS. 3 and 4. At about its middle, the bottom wall 24 defines an opening 30—this is perhaps illustrated best in FIG. 6. The opening 30 is defined completely through the bottom wall 24 and is open to the body's interior 18. In one specific example, the opening 30 has a circle shape with a diameter ranging between approximately 1 inch (25.4 mm) and approximately 1.5 inches (38.1 mm). In other examples not necessarily shown in the figures, the opening could be located at different positions on the bottom wall or on different walls (e.g., on the back wall or on the side walls) of the body; the opening could have different shapes; the size of the opening could vary and may depend on the ballast material intended to fill the body and/or the size of the plug; or a combination of these possibilities. Except for the opening 30, the body 12 generally defines a closed interior. Lastly, and referring now to FIGS. 1 and 2, the side walls 26 have a generally planar conformation and close opposite ends of the body 12.

The ballast material 14 is filled into the interior 18 in order to impart weight and stability to the parking-assist curb 10. The ballast material 14 is depicted best in FIG. 3. It can partially fill the interior 18, or completely and fully fill the interior. In either case, the ballast material 14 enters and exits the interior 18 via the opening 30. The exact ballast material 14 can vary in different examples. In the example in which the parking-assist curb 10 is a commercial and consumer product, the ballast material 14 may be something that is readily available to a consumer such as water, sand, pea gravel, dirt, smaller rocks, or a combination thereof, or something else that adds weight and stability to the parking-assist curb 10.

Referring now to FIGS. 5 and 6, the plug 16 is inserted into the body's opening 30 in order to close the opening. There can be a single plug 16 and single opening 30 for a particular parking-assist curb 10 in order to simplify the construction of the parking-assist curb and minimize occasions for leakage of the ballast material 14. When inserted, the plug 16 closes the opening 30 so that the ballast material 14 remains inside of the interior 18 and is precluded from leaking out.

The example plug 16 shown here has a generally disk or puck shape that generally resembles and complements the shape of the opening 30. In one specific example, the plug 16 has a diameter ranging from approximately 1.5 inches (38.1 mm) to approximately 2.0 inches (50.8 mm); in other examples, other diameters are possible. The plug 16 could have other shapes in other examples, and its shape can be dictated in part by the shape of the opening 30. It can be made of a rubber material via an injection molding process, or can be made of another material and via another manufacturing process. The rubber material is pliable so that a user can press and force-fit the plug 16 into the opening 30. At its inserted end the plug 16 has a leading or top surface 32, and at its opposite end the plug has a trailing or bottom surface 34. In the example depicted, the top surface 32 has a generally hemispherical shape (FIG. 5) and arcuate shape in sectional profile (FIG. 6). The top surface 32 includes a cammed surface 36 around a peripheral section of the top surface. In this example the cammed surface 36 is a ring-shaped section of the top surface 32 and is the section of the top surface that engages a portion 38 of the body 12 upon insertion of the plug 16 into the opening 30. The portion 38 has an inside surface 40 that defines the opening 30. The cammed surface 36 is sloped with respect to a bottom surface 42 of the bottom wall 24 to facilitate insertion of the plug 16 and allow it to ride into the opening 30 more readily than if the top surface 32 were merely planar and flat. The cammed surface 36 can have other conformations in other examples including a slanted planar surface that is not necessarily rounded. When inserted as shown in FIG. 6, the bottom surface 34 of the plug 16 is generally planar and mostly flush with the bottom surface 42 so that the parking-assist curb 10 is not measurably raised off of the ground G via the plug, and instead the parking-assist curb is mostly level with the ground when set on the ground.

In order to stay in place once inserted, the plug 16 has a groove 44. The groove 44 is continuously defined around the circumference of the body 12, though need not be and instead could be defined around only a part of the body; indeed, the exact design and extent of the groove may be dictated by the design of the opening 30 and by the capability of providing a secure mating between the portion 38 and the groove. Because the groove 44 extends into and inward of the body 12, it forms a first flange 46 overhanging the groove and a second flange 48 underlying the groove. When the portion 38 is received in the groove 44, the first and second flanges 46, 48 sandwich and capture the portion for a secure and completed insertion. To help ensure a secure and completed insertion, the first and second flanges 46, 48 each have an outboard extent E₁ (FIG. 6) that is greater in value than an extent E₂ (in this example, diameter) of the opening 30. In the example of FIG. 6, the first and second flanges 46, 48 have an equivalent outboard extent E₁, but need not in other examples. Further, the extent E₂ also serves as the extent of the groove 44.

The first flange 46 has a somewhat triangular shape in sectional profile (FIG. 6) due in part to the cammed surface 36, while the second flange 48 has a somewhat rectangular shape in sectional profile. Their shapes facilitate their functions in some regards. That is, the triangular shape helps initial insertion, and the rectangular shape helps stop the insertion movement once the portion 38 is received in the groove 44. Lastly, the groove 44 is defined in part by a first flange surface 50, a second flange surface 52, and an inside surface 54 spanning between the first and second flange surfaces. These surfaces 50, 52, 54 directly confront surfaces of the portion 38 and make surface-to-surface contact with them upon completed insertion as shown in FIG. 6.

In use, the parking-assist curb 10 sets on the ground G without permanent or semi-permanent fixation and attachment to the ground such as by bolting, staking, or cementing. This way, the parking-assist curb 10 can be moved around by the user for re-use and replacement if needed.

While the forms of the parking-assist curb detailed in this description constitute illustrative embodiments, other embodiments are possible. The inventors do not intend to mention all of the possible embodiments of the parking-assist curb. It is understood that the terms used herein are merely descriptive, rather than limiting, and that various changes may be made without departing from the spirit or scope of the invention.

1. A parking-assist curb, comprising:
a body having at least one wall, the wall having an abutment region engageable with a vehicle tire and having a bottom region that confronts the ground upon which the parking-assist curb is situated, the body having an opening, and the body defining an interior for locating a ballast material therein; and
a plug having a groove, wherein, in order to close the opening in the body, the plug is inserted into the opening and the groove captures a portion of the body that at least partly surrounds the opening.

2. The parking-assist curb of claim 1, wherein the wall also has a back region situated opposite the abutment region, and has a pair of side regions.

3. The parking-assist curb of claim 1, wherein the opening is the sole opening in the body and the body defines a closed interior except for the opening in the body.

4. The parking-assist curb of claim 1, wherein the abutment region is generally planar and makes an angle with respect to the ground that ranges between approximately 50 degrees (° ) and 70°, inclusive.

5. The parking-assist curb of claim 1, wherein the plug has a cammed surface that facilitates the plug's insertion into the opening.

6. The parking-assist curb of claim 1, wherein the groove is a single continuous groove extending around the plug.

7. The parking-assist curb of claim 1, wherein the groove is defined in part by a first flange surface, a second flange surface, and an side surface spanning between the first and second flange surfaces, and wherein, upon closing the opening with the plug, the first flange surface, second flange surface, and inside surface confront surfaces of the portion of the body that at least partly surrounds the opening.

8. The parking-assist curb of claim 1, wherein the parking-assist curb is situated on the ground so that it is movable on the ground and lacks a permanent fixation to the ground.

9. The parking-assist curb of claim 1, further comprising a ballast material located within the interior of the parking-assist curb's body.

10. The parking-assist curb of claim 1, wherein the at least one wall includes a plurality of walls, and the abutment region is an abutment wall and the bottom region is a bottom wall.

11. A parking-assist curb, comprising:
a body having at least one wall, a single opening defined in the at least one wall, and an interior defined by the at least one wall; and
a plug insertable in the opening in order to close the opening, the plug having a groove, a first flange, and a second flange, the groove being defined in part by a first flange surface of the first flange, a second flange surface of the second flange, and an inside surface spanning between the first and second flange surfaces, the first and second flanges having an outboard extent that is greater than an extent of the groove;
wherein, when the plug is inserted into the opening, a portion of the wall that at least partly surrounds the opening is received in the groove and the first and second flange overlie the portion of the wall in order to maintain insertion of the plug into the opening.

12. The parking-assist curb of claim 11, wherein the plug has a top surface and a bottom surface, the top surface including a cammed surface around a peripheral section of the top surface, the cammed surface being sloped relative to a surface of the portion of the wall in order to facilitate insertion of the plug into the opening, the cammed surface engaged by the portion of the wall amid insertion of the plug into the opening, the bottom surface being generally planar.

13. The parking-assist curb of claim 12, wherein the bottom surface of the plug is substantially flush with the surface of the portion of the wall.

14. The parking-assist curb of claim 13, wherein the opening is located in a bottom wail of the body, the bottom wall confronting the ground upon which the parking-assist curb is situated when put in use, and when the plug is inserted into the opening, the plug and the opening confront the ground when the parking-assist curb is situated on the ground.

15. The parking-assist curb of claim 14, wherein the parking-assist curb is free of a permanent fixation to the ground when the parking-assist curb is in use.
